(19) United States
(12) Patent Application Publication
(10) Pub. No.: US 2020/0402077 A1
(43) Pub. Date: Dec. 24, 2020

(54) MODEL PREDICTIVE CONTROL USING SEMIDEFINITE PROGRAMMING

(71) Applicant: Saudi Arabian Oil Company, Dhahran (SA)

(72) Inventors: Ibrahim Alabdulmohsin, Al-Khubar (SA); Muhammad Azmi Idris, Dhahran (SA)

(21) Appl. No.: 16/447,286

(22) Filed: Jun. 20, 2019

(51) Int. Cl. G06Q 30/02; G06N 7/00; G06F 17/16

(52) U.S. Cl. CPC G06Q 30/0202; G06F 17/16; G06N 7/00; G06Q 30/0201

(57) ABSTRACT

Systems and methods include a method for optimizing an action at a facility using a prediction of a target variable. Historical data is collected for a set of facilities. The historical data includes transactional data for discrete events that occurred at the set of facilities and non-transactional data spanning continuous time periods. Semidefinite matrices are generated using the historical data, where the semidefinite matrices incorporate historical samples of a form (yₜ, xₜ, zₜ), and where yₜ is a target variable to be predicted at time t, xₜ is an input parameter at time t, and zₜ is an environment variable at time t. A statistical model based on the semidefinite matrices is determined. Production at a facility is monitored, including collecting production data comprising the transactional data and the non-transactional data of the facility. Using the statistical model and the production data, a prediction of a target variable associated with operating conditions at the facility is determined. An action at the facility is optimized using the prediction of the target variable yₜ.

### BACKGROUND

The present disclosure applies to predictive techniques. In sectors such as oil and gas, transportation, retail markets, accommodation, and information security, companies are typically concerned with optimizing their operations in order to maximize revenues. Optimization-based solutions often rely on building accurate predictive models. Some common approaches for implementing predictive models typically use standard machine learning algorithms, such as linear regression, logistic regression, and random forests. After the predictive model is built, optimization or control can be done. Some problems with the use of standard machine learning models can exist. First, some approaches (such as those based on non-parametric regression trees) can require a large number of training examples to prevent risks of overfitting. Second, approaches that use more simple algorithms (such as logistic regression) are not guaranteed to provide models that fulfill the monotonicity constraints arising in some domains, such as plant maintenance and demand prediction.

### SUMMARY

The present disclosure describes techniques that can be used for advanced analytics and, more specifically, predictive analytics. For example, systems and methods can be used to predict future conditions in response to known input parameters and to choose optimal actions accordingly. An optimal action can be set to optimize a figure of merit, such as system reliability, availability, maintenance costs, or revenues. As an example, predictive models using semidefinite programming can be used to predict crude oil prices. For example, optimizing a figure of merit can refer to achieving figure of merit values that indicate or result in a performance above a predefined threshold.

In some implementations, a computer-implemented method includes the following. Historical data is collected for a set of facilities. The historical data includes transactional data for discrete events that occurred at the set of facilities and non-transactional data spanning continuous time periods. Semidefinite matrices are generated using the historical data, where the semidefinite matrices incorporate historical samples of a form (yₜ, xₜ, zₜ), and where yₜ is a target variable to be predicted at time t, xₜ is an input parameter at time t, and zₜ is an environment variable at time t. A statistical model based on the semidefinite matrices is determined. Production at a facility is monitored, including collecting production data comprising the transactional data and the non-transactional data of the facility. Using the statistical model and the production data, a prediction of a target variable associated with operating conditions at the facility is determined. An action at the facility is optimized using the prediction of the target variable yₜ.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, providing techniques that realize one or more of the following advantages. First, the techniques can work well with a modest-sized data set, providing an advantage over similar non-parametric approaches requiring larger amounts of data, such as those based on random forests or clustering methods. Second, through the use of regularization and cross-validation, the techniques are less susceptible to overfitting. Third, the techniques can provide outputs that adhere to desired monotonicity constraints across all environments by learning matrices over the positive semidefinite cone (the set of all symmetric positive semidefinite matrices of a particular dimension). Fourth, the techniques can provide an interpretable model, which can be explained and described to stakeholders.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a flow diagram of an example of a process for predicting a target variable, according to some implementations of the present disclosure.

FIG. 2 is a block diagram illustrating an example of a system architecture, according to some implementations of the present disclosure.

FIGS. 3A and 3B are graphs showing examples of samples of test data, according to some implementations of the present disclosure.

FIG. 4 is a flowchart of an example of a method for optimizing an action at a facility using a prediction of a target variable, according to some implementations of the present disclosure.

FIG. 5 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for predictive modeling and adaptive control systems. In particular, the present disclosure relates to methods and systems for determining the impact of a given set of predictors on unknown variables. The present disclosure describes a system, apparatus, and method for predictive modeling by means of semidefinite programming. For example, given a list of known variables and an unknown target variable, the system can predict the value of the unknown variable while also meeting required monotonicity constraints.

Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

In some implementations, techniques used for predictive modeling can include the use of semidefinite programming. For example, using historical data, positive semidefinite matrices can be built that generate a predictive model that satisfies required monotonicity constraints and has a minimal risk of overfitting. Predictive modeling systems can be recalibrated to improve accuracy as more data becomes available. Predictive modeling techniques can include producing an engine for forecasting unknown future variables, such as facility operating conditions. In some implementations, the predictive modeling techniques can be implemented as a system that can be used in determining a set of optimal actions to take in a manner that optimizes a figure of merit, such as system reliability, availability, or cost.

System use can include the following terms and concepts. A system user can refer to an individual, organization, corporation, association, or entity that provides activities related to predictive or prescriptive analytics, such as prediction, forecasting, and optimization. Predictive analytics can refer to the use of machine learning and applied statistics to predict unknown conditions based on available data. Two general domains that fall under predictive analytics are classification and regression.

In predictive analytics, there are unknown variables y₁, y₂, . . . , yₘ, which depend (either directly or indirectly) on a set of known predictors x₁, x₂, . . . , xₙ. Generally, the predictors x₁, x₂, . . . , xₙ (also called attributes or features) are known to the system, but the values of the variables y₁, y₂, . . . , yₘ are unknown. The goal of the system is to predict the values of the unknown variables upon observing values of the known predictors.

One example of predictive analytics is to predict the future conditions of operating facilities. The list of known variables may include, but are not limited to, sensor measurements, plant maintenance transactions, notifications, and safety observations. The unknown variables may correspond to, but are not limited to, whether or not a system would fail in a given period of time.

The appropriate prediction algorithm can differ from one application to another. For classification, examples of prediction algorithms include support vector machine learning, logistic regression, decision trees, nearest neighbor methods, and neural networks. For use in regression techniques, popular algorithms can include least squares regression, Lasso, and radial basis function (RBF) networks. The performance of each algorithm can depend on various factors, such as the choice of the predictors, hyperparameters, and the training/validation method. As such, predictive analytics can include automatic and semi-automatic tasks. The tasks can include, for example, an iterative process of knowledge discovery or an interactive multi-objective optimization that involves trial and error. Processes can often include steps to modify data preprocessing and model parameters until a result achieves desired properties.

Predictive analytics techniques can be categorized as supervised learning methods because a “correct” answer is always available. System goals can include a goal to answer questions correctly. By contrast, unsupervised learning methods, such as clustering, do not have a well-defined measure of success, since a “correct” answer is not always known.

One example domain or segment that can benefit significantly from predictive analytics is plant maintenance. In several industry and service sectors, such as oil and gas sectors, transportation, and information technology, many companies are concerned with optimizing maintenance cost. By predicting the failures of equipment before the failures occur, a preventive maintenance strategy can be optimized to reduce costs and improve system availability.

A second example domain that can benefit from predictive analytics is generalized predictive control (GPC), where system dynamics are controlled by perturbing the system input parameters to generate a desired state. In this case, predictive analytics can be used to predict the impact of perturbation.

Another example domain that can benefit from predictive analytics is sales and marketing. For example, customer reaction to prices (for example, demand) can be predicted using data analytics. In another example, an optimal price can be selected according to a demand model. An example application of demand estimation is to forecast the impact of sales promotions. Another example application of demand estimation is related to inventory management and production planning. For example, by accurately forecasting the demands for products, the user can determine the level of on-hand inventory and plan for production accordingly.

Another domain that can benefit from predictive analytics is environmental science, where predictive methods that are based on machine learning can replace physics-based simulation modeling. In this example, machine learning can provide an advantage of simplifying the system design.

Another domain that can benefit from predictive analytics is biology. For example, protein remote homology detection is a central problem that is typically solved effectively using machine learning algorithms, such as support vector machines, using carefully crafted protein similarity measures. Similarly, predicting the protein folding structure for its amino acid sequence can benefit greatly from advanced predictive analytics.

Another domain that can benefit from predictive analytics is information security. For example, network intrusion prevention systems and intrusion detection systems can be built using machine learning algorithms to detect intrusions based on signatures.

System can be built using predictive analytics, for example, allowing a system to be entirely or partially data-driven. Furthermore, a system can improve its performance over time by incorporating new data points.

Predictive analytics, in general, can pose a unique set of challenges. For example, in some domains, some unknown variables can depend on several known predictors. Relationships between variables and predictors can sometimes be known to satisfy certain monotonicity constraints. For instance, the likelihood of a failure can be represented as an increasing function of equipment age. A customer demand curve can be represented as a decreasing function of price. The likelihood of network intrusion can be represented as a function that increases with the level of deviation of the norm.

Variables and predictors can be related mathematically, for example, as y=f(z)·x+g(z), where y is the unknown variable to be predicted, x is some input variable, and z is the “environment.” To satisfy the required monotonicity constraints, the function f(z) may need to satisfy f(z)≥0 or f(z)≤0 under all environments z.

Techniques of the present disclosure can be used to model unknown functions using quadratic forms, where vectors encode all of the predictors (for example, making up the environment), while matrices define the model to be learned from the data. The matrices can be assumed to lie in the positive semidefinite cone in order to satisfy required monotonicity constraints.

In some implementations, the system can be used to predict maintenance costs, for example, as a function of equipment age. In this example, the relationship between maintenance cost and age can be governed by a set of environment variables that describe the type of the equipment and its manufacturer. For a chosen environment, a monotonicity condition can arise because maintenance cost, on average, increases with equipment age.

In some implementations, the system can be used to predict customer reaction to prices (for example, crude oil prices) for combinations of different markets and different products (for example, different crude grades). The system can generate a forecast of demand, identify key market conditions, and compute price elasticity figures for different market-product combinations. In some implementations, monotonicity can arise from the observation that demand must always be a non-increasing function of price.

In some implementations, an adaptive control system can be developed, such as multivariate-input single-output systems for controlling mechanical systems or electronics. The system can perform real-time estimation of system parameters, predict the output of each possible action, and select an optimal action accordingly.

Historical data that is used in predictive modeling and semidefinite programming can include transactional data (for example, maintenance history) and non-transactional data (for example, sensor measurements). The historical data can be associated with a list of known variables (predictors) that can include a number of features, depending on the application at hand.

Writing y for the target variable, x for the input variable, and z as a vector that encodes the entire environment, the target variable can be decomposed into a sum of two terms. The first term (or intercept term) does not depend on the input x. The second term (or sensitivity term) measures the impact of x on y, given the environment z. Mathematically, the target variable can be expressed as y=α(z)+β(z)·x, where α(z) is the intercept and β(z) is the sensitivity (slope). For example, y indicates the frequency of failures, x indicates the age of the equipment, and z describes the type of equipment and its manufacturer. A goal of using the target variable is to compute the functions α(z) and β(z) given the environment conditions (z₁, z₂, zₙ). Because the overall target variable can be a monotone function of x, one must either have β(z)≥0 or β(z)≤0 for all market conditions (z₁, z₂, zₙ).

The intercept term can be modeled using a standard machine learning algorithm, such as log-linear regression, least squares, random forests, or RBF neural networks. The choice of the particular algorithm can be inconsequential with respect to implementations of the present disclosure.

The sensitivity term (or slope) can be modeled as a quadratic form, using a positive semidefinite matrix in order to guarantee that the demand is a monotone function of the input parameter x. Specifically, the sensitivity term can use β(z)=z^{T}Bz, for some symmetric matrix B. As such, the symmetric matrix can be required to lie either in a positive semidefinite cone β≥0 or a negative semidefinite cone β≤0, depending on whether or not y is a monotonically increasing or decreasing function of x.

According to spectral theorem constructs, every symmetric matrix has an eigenvalue decomposition. A symmetric matrix is called positive semidefinite if and only if all of its eigenvalues are non-negative.

The system and techniques described in the present disclosure can capitalize on historical data to build the model α(z) and the positive semidefinite matrices. In some implementations, both α(z)=z^{T}Az and β(z)=z^{T}Bz, where A≥0 and B≥0 are symmetric positive semidefinite. Hence, to estimate the values of the matrices using historical data, one can minimize Σₜf(yₜ, zₜ^{T}Azₜ−(zₜ^{T}Bzₜ)·xₜ) subject to the constraints A≥0 and B≥0, where (yₜ, xₜ, zₜ) are historical examples that comprise target yₜ, input xₜ, and environment zₜ. The function f above can be any loss function, such as the square loss function or the Huber loss function. One rationale behind techniques of the present disclosure is to avoid overfitting by learning parameters using a parametric method, such as least squares regression. The parametric method is used while simultaneously imposing the positive semi-definiteness constraint in order to guarantee that the models adhere to the required monotonicity constraints across all possible environments z.

In some implementations, output generated by the system can include information that is presented to the user, for example, in a user interface (UI) in the form of reports and dashboards. For example, dashboards can include graphs that plot the predicted target y. The graphs can be accompanied by informational displays that present corresponding computed sensitivity figures. The UI can also highlight the most influential environment conditions by absolute value. Other outputs of the system can include notifications (for example, email messages) and automatic updates to production systems (for example, oil-drilling operations).

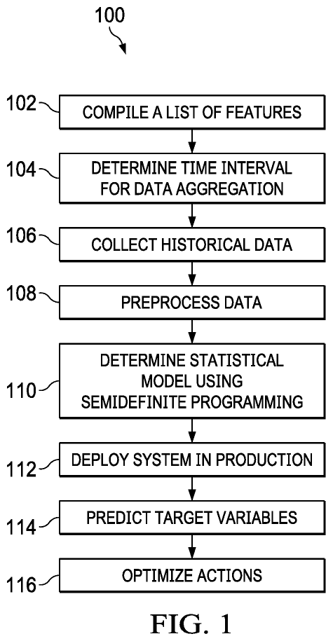

FIG. 1 is a flow diagram of an example of a process 100 for predicting a target variable, according to some implementations of the present disclosure.

At 102, a list of features is compiled. For example, a list of input parameters xₜ and their corresponding environments zₜ can be compiled.

At 104, time interval for data aggregation is determined. The time interval can be, for example, a time period spanning several days to several months. Time intervals can be selected by a user through a user interface.

At 106, historical data is collected. For example, historical data of the form (yₜ, xₜ, zₜ) can be gathered, where yₜ is the target, xₜ is the input parameter, and zₜ is the environment.

At 108, data is preprocessed. As an example, the model can be trained on preprocessed data using semidefinite programming.

At 110, a statistical model is determined using semidefinite programming. The statistical model can be based on statistics associated with transactional data (for example, maintenance history) and non-transactional data (for example, sensor measurements).

At 112, the system is deployed in production. For example, computerized locations that monitor and control production at oil facilities can receive the software and data that are used to execute the system.

At 114, target variables are predicted. As an example, as the system is run at a computerized location that monitors and controls production at an oil facility, the system can predict target variables.

At 116, actions are optimized. For example, the system can generate new predictions, which are used for generating optimal actions. Optimal actions, for example, can be suggested to a user using a user interface, and user selection of a suggestion can cause automatic use of the information in the computerized location that monitors and controls production at the oil facility.

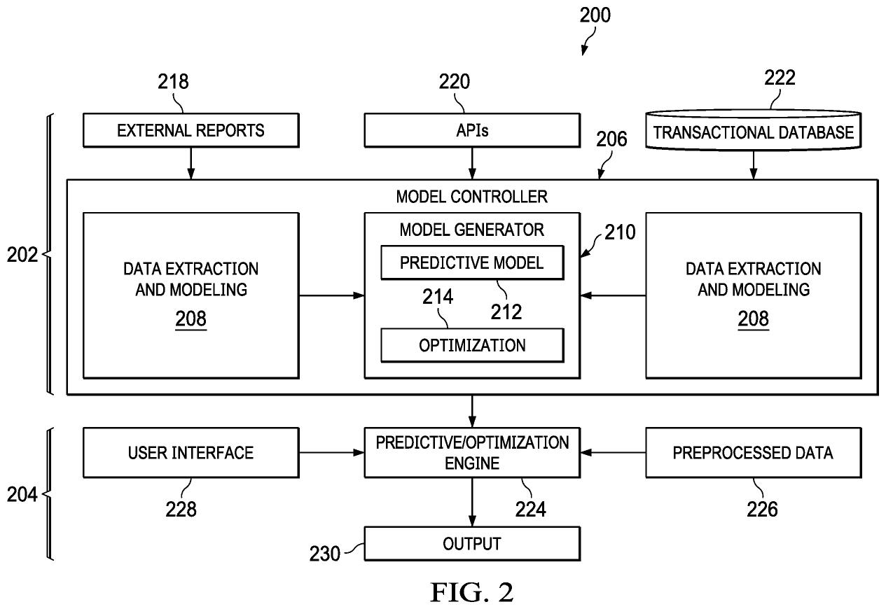

FIG. 2 is a block diagram illustrating an example of an architecture of a system 200, according to some implementations of the present disclosure. For example, the system 200 can implement the techniques of the present disclosure. The system 200 can include modular components, including modules for data collection, data preprocessing, statistical modeling, and optimization. The system 200 can be used for data collection, training, validation, and prediction.

The system 200 can include a data processing system that includes and executes application code. The application code can contain instructions for carrying out the techniques and processes described in the present disclosure.

The modules of the system 200 can be implemented in layers 202-204. In a model controlling layer 202, for example, a model controller 206 can perform modeling functions of the system 200, including collecting data from multiple sources through extraction and generating a model using modeling modules (or components). For example, data that is collected by the model controller 206 can be used to generate the predictive and optimization models. The model controller 206 can include one or more data extraction and modeling modules 208 that extract data, such as historical data, to perform modeling. A model generator 210, which generates the model, can include a predictive model module 212 and an optimization module 214. Inputs to the model controller 206 can include external reports 218, application programming interfaces (APIs) 220, and transactional databases 222 (for example, identifying transactional data and non-transactional data).

Within a predictive layer 204, a predictive/optimization engine 224 can use preprocessed data 226 and a user interface 228 to produce an output 230. For example, once the predictive engine is determined, the predictive engine can receive data and user input to generate a dashboard or a report.

In some implementations, the user can interact with the system 200 through a graphical user interface (GUI) (for example, at an oil production facility or on a mobile device) and a web browser operating on a client machine. Processing and modeling performed by the system 200 can execute on a server and can have direct access to historical data needed to generate the model.

The system 200 can be used to predict future conditions upon learning a corrected model. In an example, an oil-producing company can use market conditions, such as refinery utilizations, freight rates, supply/demand gaps, and exchange rates to build a predictive model using semidefinite programming based on historical data. The model can be corrected (or fine-tuned) over time as more data becomes available and is used to update the model. Market conditions can be applied against the model, for example, to measure demand and forecast price elasticity.

In some implementations, features can be preprocessed, normalized, or subjected to feature-selection processes. In addition, depending on domain knowledge, additional constraints can be imposed on coefficients used in the positive semidefinite matrices, such as by imposing non-negativity constraints on individual matrix elements. In some implementations, regularization terms can be used with the matrices to further mitigate the risk of overfitting. The choice of the hyperparameters can be made using techniques such as cross-validation, leave-one-out estimation, or using model selection techniques. One example of a hyperparameter is a tradeoff constant between accuracy and model complexity. For example, the model complexity can be measured using a matrix norm of the positive semidefinite matrices.

In some implementations, specialized optimization engines can be used for solving semidefinite programs. The specialized optimization engines can use heuristic methods for optimization, including using various approximation techniques.

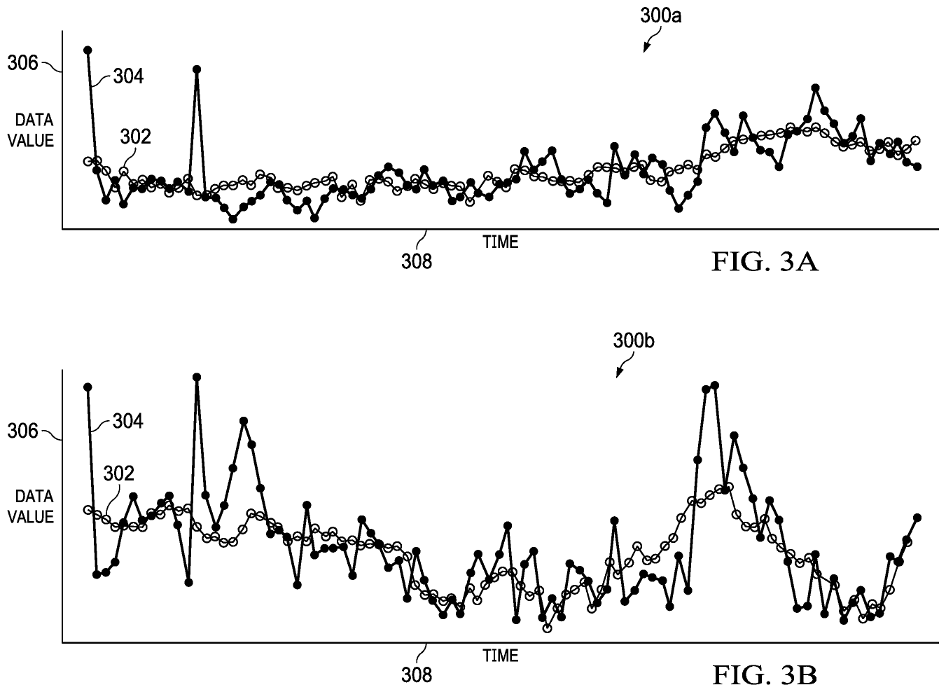

FIGS. 3A and 3B are graphs 300a and 300b, respectively, showing examples of samples of test data, according to some implementations of the present disclosure. The graphs 300a and 300b show comparisons of predicted values of an unknown variable versus the actual values. For example, curves 302 correspond to the model predictions whereas the curves 304 correspond to the actual values. The curves 302 and 304 are plotted relative to a data value axis 306 and a time axis 308.

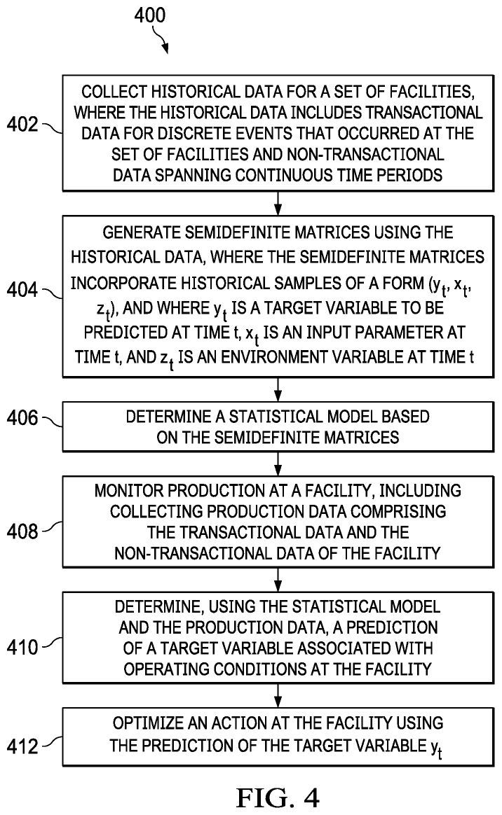

FIG. 4 is a flowchart of an example of a method 400 for optimizing an action at a facility using a prediction of a target variable, according to some implementations of the present disclosure. For clarity of presentation, the description that follows generally describes method 400 in the context of the other figures in this description. However, it will be understood that method 400 can be performed, for example, by any suitable system, environment, software, and hardware, or a combination of systems, environments, software, and hardware, as appropriate. In some implementations, various steps of method 400 can be run in parallel, in combination, in loops, or in any order.

At 402, historical data is collected for a set of facilities. The historical data includes transactional data for discrete events that occurred at the set of facilities and non-transactional data spanning continuous time periods. For example, the model controller 206 can receive transactional information from the transactional database 222. From 402, method 400 proceeds to 404.

At 404, semidefinite matrices are generated using the historical data, where the semidefinite matrices incorporate historical samples of a form (yₜ, xₜ, zₜ), and where yₜ is a target variable to be predicted at time t, xₜ is an input parameter at time t, and zₜ is an environment variable at time t. As an example, the model controller 206 can analyze and aggregate the transaction information received from the transactional database 222 to generate time-based matrix entries that include target variable, input parameter, and environment relationships. From 404, method 400 proceeds to 406.

At 406, a statistical model based on the semidefinite matrices is determined. For example, the model generator 210 can generate the model used by the system 200. From 406, method 400 proceeds to 408.

At 408, production at a facility is monitored, including collecting production data comprising the transactional data and the non-transactional data of the facility. As an example, production information for an oil facility can be monitored and collected over time. The information that is collected can include transactional data and non-transactional data. From 408, method 400 proceeds to 410.

At 410, using the statistical model and the production data, a prediction of a target variable associated with operating conditions at the facility is determined. For example, equipment failures can be predicted before the failures occur. In some implementations, prediction information can be presented to a user in a user interface (U/I) at the facility or a remote location that interacts with the facility. From 410, method 400 proceeds to 412.

At 412, an action at the facility is optimized using the prediction of the target variable yₜ. As an example, a preventive maintenance strategy can be optimized to reduce costs and improve system availability, such as to schedule replacement or maintenance of equipment that is predicted to fail. In some implementations, the user can use the U/I to select actions (or approve suggested actions) based on the prediction information that is presented. For example, the actions can include automatically scheduling equipment repair or maintenance, sustaining operations as needed (for example, if an immediate failure is predicted), or updating parameters used in production processes at the facility (for example, to change how the equipment is used or loaded). Actions can occur based on the predictions and selections by the user can be implemented in real-time, for example, causing events to occur within a specified period of time, such as within one minute, within one second, or within milliseconds. After 412, method 400 can stop.

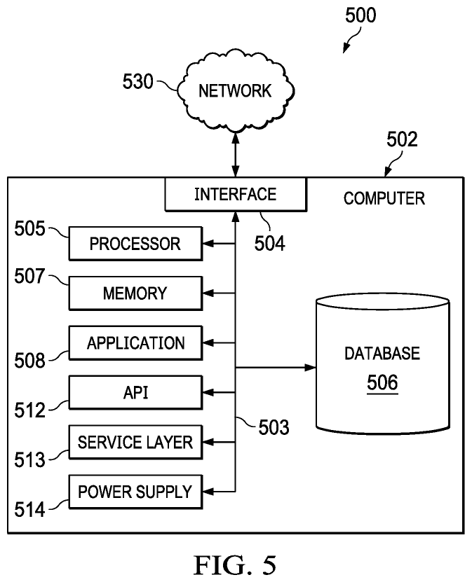

FIG. 5 is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a high level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both), over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Described implementations of the subject matter can include one or more features, alone or in combination.

For example, in a first implementation, computer-implemented methods include a method for optimizing an action at a facility using a prediction of a target variable. Historical data is collected for a set of facilities. The historical data includes transactional data for discrete events that occurred at the set of facilities and non-transactional data spanning continuous time periods. Semidefinite matrices are generated using the historical data, where the semidefinite matrices incorporate historical samples of a form (yₜ, xₜ, zₜ), and where yₜ is a target variable to be predicted at time t, xₜ is an input parameter at time t, and zₜ is an environment variable at time t. A statistical model based on the semidefinite matrices is determined. Production at a facility is monitored, including collecting production data comprising the transactional data and the non-transactional data of the facility. Using the statistical model and the production data, a prediction of a target variable associated with operating conditions at the facility is determined. An action at the facility is optimized using the prediction of the target variable yₜ.

The foregoing and other described implementations can each, optionally, include one or more of the following features:

A first feature, combinable with any of the following features, where yₜ is given by a function y=f(z)·x+g(z).

A second feature, combinable with any of the previous or following features, where f(z) satisfies f(z)≥0 for all z or f(z)≤0 for all z.

A third feature, combinable with any of the previous or following features, where the transactional data includes maintenance history data and the non-transactional data includes sensor measurements.

A fourth feature, combinable with any of the previous or following features, where the action is an optimizing action for optimizing a figure of merit, such as system reliability, availability, maintenance costs, or revenues.

A fifth feature, combinable with any of the previous or following features, where determining the prediction of the target variable yₜ is further based on market conditions including refinery utilizations, freight rates, supply/demand gaps, and exchange rates.

A sixth feature, combinable with any of the previous or following features, the method further comprising providing, for presentation to a user in a user interface, recommendations for optimizing the action at the facility.

In a second implementation, a non-transitory, computer-readable medium storing one or more instructions executable by a computer system to perform operations including the following operations. Historical data is collected for a set of facilities. The historical data includes transactional data for discrete events that occurred at the set of facilities and non-transactional data spanning continuous time periods. Semidefinite matrices are generated using the historical data, where the semidefinite matrices incorporate historical samples of a form (yₜ, xₜ, zₜ), and where yₜ is a target variable to be predicted at time t, xₜ is an input parameter at time t, and zₜ is an environment variable at time t. A statistical model based on the semidefinite matrices is determined. Production at a facility is monitored, including collecting production data comprising the transactional data and the non-transactional data of the facility. Using the statistical model and the production data, a prediction of a target variable associated with operating conditions at the facility is determined. An action at the facility is optimized using the prediction of the target variable yₜ.

The foregoing and other described implementations can each, optionally, include one or more of the following features:

A first feature, combinable with any of the following features, where yₜ is given by a function y=f(z)·x+g(z).

A second feature, combinable with any of the previous or following features, where f(z) satisfies f(z)≥0 for all z or f(z)≤0 for all z.

A third feature, combinable with any of the previous or following features, where the transactional data includes maintenance history data and the non-transactional data includes sensor measurements.

A fourth feature, combinable with any of the previous or following features, where the action is an optimizing action for optimizing a figure of merit, such as system reliability, availability, maintenance costs, or revenues.

A fifth feature, combinable with any of the previous or following features, where determining the prediction of the target variable yₜ is further based on market conditions including refinery utilizations, freight rates, supply/demand gaps, and exchange rates.

A sixth feature, combinable with any of the previous or following features, the operations further comprising providing, for presentation to a user in a user interface, recommendations for optimizing the action at the facility.

In a third implementation, a computer-implemented system, including one or more processors and a non-transitory computer-readable storage medium coupled to the one or more processors and storing programming instructions for execution by the one or more processors, the programming instructions instructing the one or more processors to perform operations including the following. Historical data is collected for a set of facilities. The historical data includes transactional data for discrete events that occurred at the set of facilities and non-transactional data spanning continuous time periods. Semidefinite matrices are generated using the historical data, where the semidefinite matrices incorporate historical samples of a form (yₜ, xₜ, zₜ), and where yₜ is a target variable to be predicted at time t, xₜ is an input parameter at time t, and zₜ is an environment variable at time t. A statistical model based on the semidefinite matrices is determined. Production at a facility is monitored, including collecting production data comprising the transactional data and the non-transactional data of the facility. Using the statistical model and the production data, a prediction of a target variable associated with operating conditions at the facility is determined. An action at the facility is optimized using the prediction of the target variable yₜ.

The foregoing and other described implementations can each, optionally, include one or more of the following features:

A first feature, combinable with any of the following features, where yₜ is given by a function y=f(z)·x+g(z).

A second feature, combinable with any of the previous or following features, where f(z) satisfies f(z)≥0 for all z or f(z)≤0 for all z.

A third feature, combinable with any of the previous or following features, where the transactional data includes maintenance history data and the non-transactional data includes sensor measurements.

A fourth feature, combinable with any of the previous or following features, where the action is an optimizing action for optimizing a figure of merit, such as system reliability, availability, maintenance costs, or revenues.

A fifth feature, combinable with any of the previous or following features, where determining the prediction of the target variable yₜ is further based on market conditions including refinery utilizations, freight rates, supply/demand gaps, and exchange rates.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
collecting historical data for a set of facilities, wherein the historical data includes transactional data for discrete events that occurred at the set of facilities and non-transactional data spanning continuous time periods;
generating semidefinite matrices using the historical data, wherein the semidefinite matrices incorporate historical samples of a form (yₜ, xₜ, zₜ), and wherein yₜ is a target variable to be predicted at time t, xₜ is an input parameter at time t, and zₜ is an environment variable at time t;
determining a statistical model based on the semidefinite matrices;
monitoring production at a facility, including collecting production data comprising the transactional data and the non-transactional data of the facility;
determining, using the statistical model and the production data, a prediction of a target variable yₜ associated with operating conditions at the facility; and
optimizing an action at the facility using the prediction of the target variable yₜ.

2. The computer-implemented method of claim 1, wherein yₜ is given by a function y=f(z)·x+g(z).

3. The computer-implemented method of claim 2, wherein f(z) satisfies f(z)≥0 for all z or f(z)≤0 for all z.

4. The computer-implemented method of claim 1, wherein the transactional data includes maintenance history data and the non-transactional data includes sensor measurements.

5. The computer-implemented method of claim 1, wherein the action is an optimizing action for optimizing a figure of merit, such as system reliability, availability, maintenance costs, or revenues.

6. The computer-implemented method of claim 1, wherein determining the prediction of the target variable yₜ is further based on market conditions including refinery utilizations, freight rates, supply/demand gaps, and exchange rates.

7. The computer-implemented method of claim 1, further comprising providing, for presentation to a user in a user interface, recommendations for optimizing the action at the facility.

8. A non-transitory, computer-readable medium storing one or more instructions executable by a computer system to perform operations comprising:
collecting historical data for a set of facilities, wherein the historical data includes transactional data for discrete events that occurred at the set of facilities and non-transactional data spanning continuous time periods;
generating semidefinite matrices using the historical data, wherein the semidefinite matrices incorporate historical samples of a form (yₜ, xₜ, zₜ), and wherein yₜ is a target variable to be predicted at time t, xₜ is an input parameter at time t, and zₜ is an environment variable at time t;
determining a statistical model based on the semidefinite matrices;
monitoring production at a facility, including collecting production data comprising the transactional data and the non-transactional data of the facility;
determining, using the statistical model and the production data, a prediction of a target variable yₜ associated with operating conditions at the facility; and
optimizing an action at the facility using the prediction of the target variable yₜ.

9. The non-transitory, computer-readable medium of claim 8, wherein yₜ is given by a function y=f(z)·x+g(z).

10. The non-transitory, computer-readable medium of claim 9, wherein f(z) satisfies f(z)≥0 for all z or f(z)≤0 for all z.

11. The non-transitory, computer-readable medium of claim 8, wherein the transactional data includes maintenance history data and the non-transactional data includes sensor measurements.

12. The non-transitory, computer-readable medium of claim 8, wherein the action is an optimizing action for optimizing a figure of merit, such as system reliability, availability, maintenance costs, or revenues.

13. The non-transitory, computer-readable medium of claim 8, wherein determining the prediction of the target variable yₜ is further based on market conditions including refinery utilizations, freight rates, supply/demand gaps, and exchange rates.

14. The non-transitory, computer-readable medium of claim 8, the operations further comprising providing, for presentation to a user in a user interface, recommendations for optimizing the action at the facility.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
collecting historical data for a set of facilities, wherein the historical data includes transactional data for discrete events that occurred at the set of facilities and non-transactional data spanning continuous time periods;
generating semidefinite matrices using the historical data, wherein the semidefinite matrices incorporate historical samples of a form (yₜ, xₜ, zₜ), and wherein yₜ is a target variable to be predicted at time t, xₜ is an input parameter at time t, and zₜ is an environment variable at time t;
determining a statistical model based on the semidefinite matrices;
monitoring production at a facility, including collecting production data comprising the transactional data and the non-transactional data of the facility;
determining, using the statistical model and the production data, a prediction of a target variable yₜ associated with operating conditions at the facility; and
optimizing an action at the facility using the prediction of the target variable yₜ.

16. The computer-implemented system of claim 15, wherein yₜ is given by a function y=f(z)·x+g(z).

17. The computer-implemented system of claim 16, wherein f(z) satisfies f(z)≥0 for all z or f(z)≤0 for all z.

18. The computer-implemented system of claim 15, wherein the transactional data includes maintenance history data and the non-transactional data includes sensor measurements.

19. The computer-implemented system of claim 15, wherein the action is an optimizing action for optimizing a figure of merit, such as system reliability, availability, maintenance costs, or revenues.

20. The computer-implemented system of claim 15, wherein determining the prediction of the target variable yₜ is further based on market conditions including refinery utilizations, freight rates, supply/demand gaps, and exchange rates.
